(19) United States
(12) Patent Application Publication
(10) Pub. No.: US 2023/0008764 A1
(43) Pub. Date: Jan. 12, 2023

(54) PORTABLE BEVERAGE CONTAINER WITH INTEGRAL STIRRER

(71) Applicants: Howard A. Cuttler, Potomac, MD (US); Steve Kang, Oakton, VA (US)

(72) Inventors: Howard A. Cuttler, Potomac, MD (US); Steve Kang, Oakton, VA (US)

(21) Appl. No.: 16/877,740

(22) Filed: May 19, 2020

(51) Int. Cl. A47J 43/07

(52) U.S. Cl. CPC A47J 43/0716

(57) ABSTRACT

A beverage container with an integral stirrer is disclosed. The container includes a main body for holding a beverage. The main body is mounted on a base, which includes an electric motor for operating the stirrer, a battery compartment and a control mechanism for operating the electric motor.

### CROSS-REFERENCE TO RELATED APPLICATION

This application claims priority to provisional application No. 62/850,005 filed on May 20, 2019 and entitled “Portable Beverage Container With Integral Stirrer”, said application being fully incorporated herein by reference.

### TECHNICAL FIELD

The present invention generally relates to the field of beverage containers and more particularly, is directed to a portable beverage container with integral stirrer.

### BACKGROUND

As used herein the term “beverage” refers to a generally liquid substance which typically is consumed as refreshment. By way of example only, beverages are known in the art to include alcoholic drinks, soft drinks, frozen drinks, tea, coffee and juices.

In the past, water was known only as a means of hydration rather than as a beverage. However, health trends and the popularity of flavored and mineral enriched waters have given water the attributes of a beverage. Thus, the present invention includes water as a beverage.

Water is known in the sciences as the universal solvent because it dissolves more substances than any other liquid. Thus most beverages are a mixture of water and other ingredients.

For example, in the case of a bartender making a mixed drink for a bar patron, the ingredients are placed into a container and the container is shaken or stirred with the objective being to form a consistent mixture of the ingredients. The mixture is often transferred to another container for consumption.

Because most ingredients contain water, or water is added to the mixing container, shaking or stirring the container can lead to a consistent mixture of the ingredients.

As is known in the art, the shaking or stirring process can be done by hand or by means of an electric mixer or blender.

It is generally understood that a substance maintains its individual properties when mixed with other substances. On the other hand, substances that are used to form a compound chemically bond together in order to from a new substance. Thus, the starter substances do no retain their original properties once the bonding process is completed. The bonding process usually occurs as a result of exposing the substances to temperature and/or pressure extremes over a period of time.

Beverages that are intended for immediate consumption usually are the result of a mixture of ingredients rather than compounding the ingredients into a new substance. This is the case because subjecting the ingredients to temperature and/or pressure extremes usually is not an option. Beverages that are indeed the result of a compounding process usually are made in a central facility for later consumption.

It is known that over time mixtures tends to separate or un-mix to their individual constituent ingredients. For example, heavier ingredients tend to settle to the bottom of their container, pushing lighter weight ingredients to the top. When un-mixing occurs, the advantages gained from the mixing process, such as taste and/or consistency, are lost. The beverage must then be remixed.

The un-mixing process can occur even with ice water, i.e., water with cubes or pellets of ice. As the ice melts, the colder molecules of water sink to the bottom of the container pushing the warmer molecules upward.

While devices for stirring and shaking liquids, such as beverages, are known, the art remains devoid of a practical and efficient portable way to maintain beverages that are mixed to the desired consistency. The present invention addresses this need in the art.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is a top view of a beverage container in accordance with the present invention;

FIG. 2 is a side view of a beverage container in accordance with the present invention;

FIG. 3 illustrates the internal structure of a beverage container in accordance with the present invention showing the stirring mechanism and control circuitry;

FIGS. 4-A and 4-B are schematic diagrams of a further embodiment of the control circuitry of a beverage container in accordance with the present invention;

FIG. 5 is a top view of a beverage container in accordance with another embodiment of the present invention;

FIG. 6 is a side view of the beverage container shown in FIG. 5;

FIG. 7 is a side view of a further embodiment of a beverage container in accordance with the present inventions illustrating a decorative void along the interior wall of the container; and

FIG. 8 is a side view of a still further embodiment of a beverage container in accordance with the present inventions illustrating the flow direction of the contents of the container when the stirring mechanism is activated.

### DESCRIPTION OF THE PREFERRED EMBODIMENT

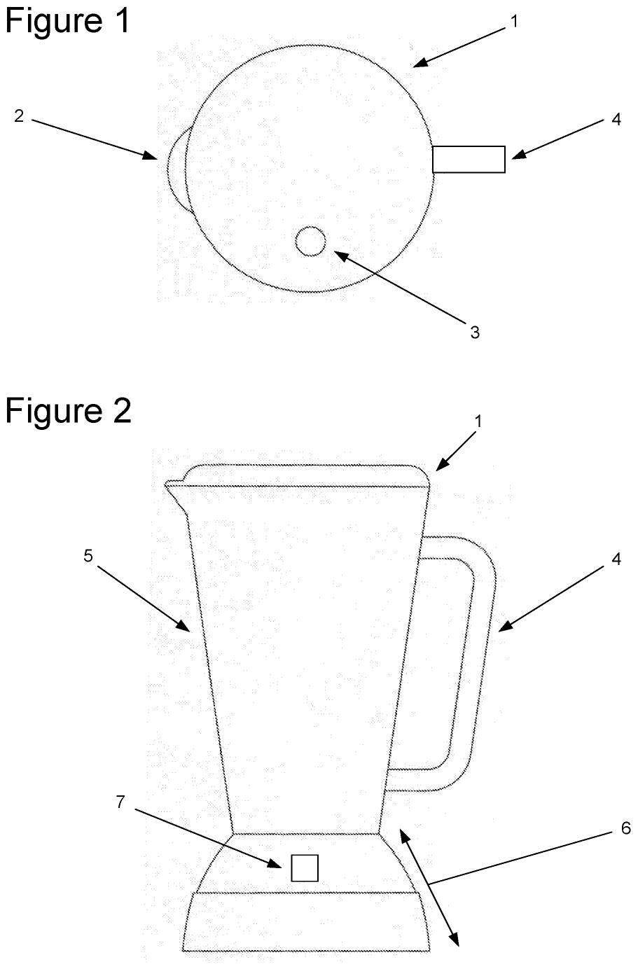

FIG. 1 is a top view of a preferred embodiment of the present invention and FIG. 2 is a side view thereof.

As shown in FIG. 1, the container includes a top or cap 1 for closing off the open upper end of the container, a spout 2 for facilitating pouring of the container contents into another container and a hole 3 through which a drinking straw can be inserted by a user of the container. The Container also includes a handle 4, which is better illustrated in FIG. 2.

In the embodiment shown in FIGS. 1 and 2, the container body 5 is mounted or attached to a base 6.

As depicted in FIG. 2, container body 5 has the shape of a pitcher. However, in accordance with the present invention, body 5 is not limited to such a shape and can be fabricated in any number of artistic and functional shapes as will be understood by one of ordinary skill in the art.

Top 1, body 5 and base 6 may be formed of different materials that are already known in the art, including, but not limited to, plastic, metal, paper and wood. Ideally, the container will be made of plastic and formed through an injection molding process. Such a process will allow body 5, handle 4 and base 6 to be integrally formed at the same time.

Control switch 7 may be used to activate and deactivate the integrally formed stirrer as set forth below. Switch 7 may be a mechanical on/off switch or may be of the pressure sensitive type requiring a sustained pressure of a predetermined length of time to activate the stirrer.

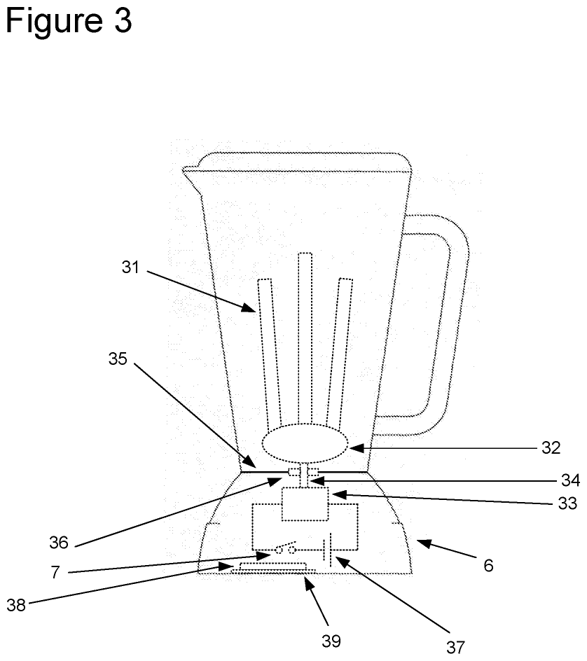

FIG. 3 illustrates the internal structure of the container of the invention in accordance with one embodiment.

The stirrer mechanism includes a plurality of stirrer blades or arms 31 which are used to stir the contents of the container when activated by control switch 7. Stirrer blades 31 are attached to a base plate 32.

As illustrated in FIG. 3, 3 stirrer blades 31 are shown attached to base plate 32. One of ordinary skill in the art will understand that a lesser or greater number of blades 31 may be used as is necessary for stirring the particular contents of the container for which the container is intended for use. The length of stirrer blades 31 may be customized to the nature of the contents of the container or the particular circumstances in which the container will be used.

Stirrer blades 31 and base plate 32 may be made of a number of materials, such as plastic, as one of ordinary skill in the art will understand.

Base plate 32 is rotated by an electric motor 33 located in base 6 via a drive shaft 34. Drive shaft 34 protrudes through bottom wall 35 of container 5 in a leak proof manner through the use of sealed bearing 36. Motor 33 is powered by battery 37 through control switch 7.

Motor 33 may be selected from a number of electric motors as are known in the art. Ideally, motor 33 will be a 1½ to 3 volt type which allows it to be driven by battery 37 of similar voltage.

Motor 33 and battery 37 may be attached to the interior of base 6 using conventional attachment techniques. For example, battery 37 may be mounted in a battery compartment 38 at the bottom of base 6 and be accessible through a cover 39 for replacement when necessary.

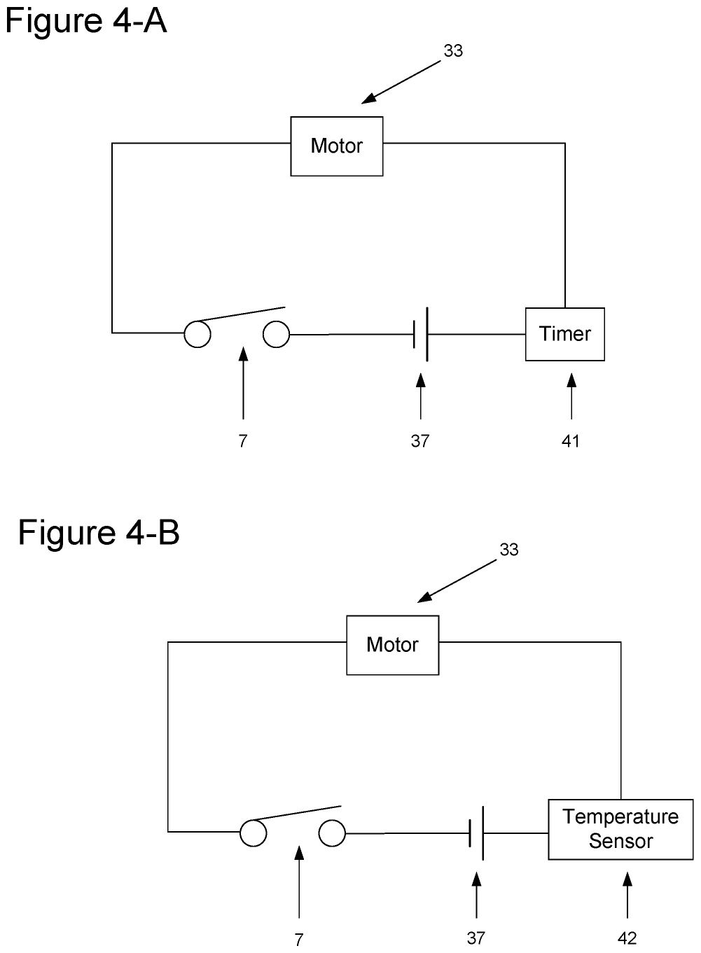

FIG. 4-A is a schematic diagram of an alternative control circuit for motor 33. In this embodiment, a timer 41 is used to automatically activate motor 33 at preset intervals once the control circuit is turned on by control switch 7.

FIG. 4-B is a schematic diagram of a further embodiment of a control circuit for motor 33. In this embodiment, a temperature sensor 42 is provided which, alone or in conjunction with control switch 7, activates motor 33 when the temperature in the container falls or rises to a predetermined level. Sensor 42 may be strategically positioned in or on container 5 as necessary to achieve the desired result.

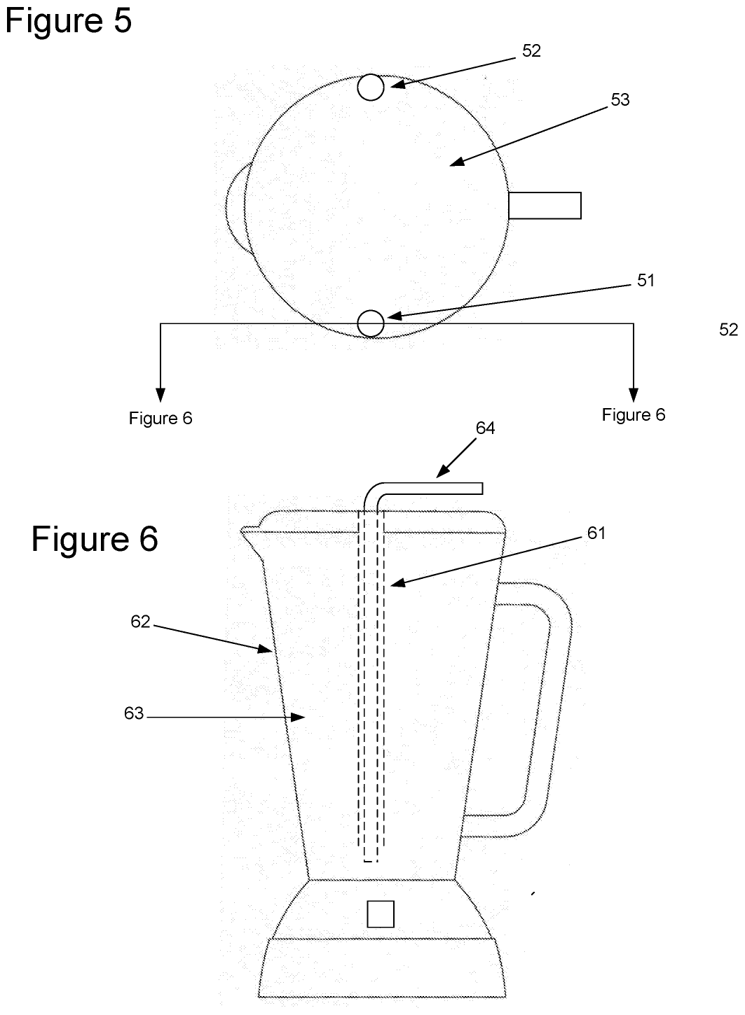

FIGS. 5 and 6 illustrate a further embodiment of the present invention. In this embodiment a plurality of straw holes 51 and 52 are provided in cap or top 53. The straw holes open to a corresponding pair of channels 61 formed in wall 62 of container 63 and allow draw 64 to be inserted into chamber 63 without interfering with stirrer blades 31 shown in FIG. 3.

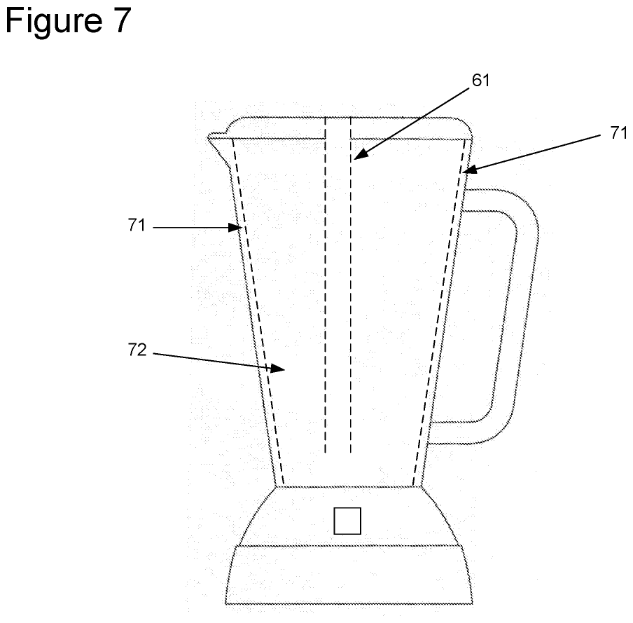

FIG. 7 illustrates a still further embodiment of the present invention wherein a sealed void 71 is formed along the inside wall of container 71. Void 71 may be filled with declarative material or liquid in order to give the container a more pleasing and stylish appearance. Provisions may also be made to provide illumination to high light the declarative nature of the material or liquid in void 71. Such illumination may be provided by, for example, light emitting diodes (LEDs) that may also be powered by battery 37 shown in FIG. 37 as one of ordinary skill in the art would know how to do.

In the embodiments illustrated in FIG. 7, at least a portion of the outer wall of the container will be transparent, thus allowing the decorative material or liquid to be seen from the outside.

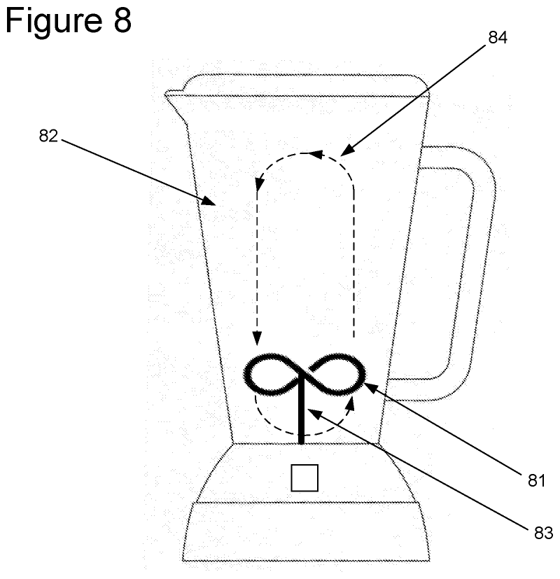

FIG. 8 illustrates a still further embodiment of the present invention wherein a propeller blade 81 is provided to re-mix the contents inside container 82 when needed. Blade 81 is driven by shaft 83 coupled to, for example, motor 33 shown in FIG. 3.

The profile of blade 81 is designed so that as it rotates, the contents of the container along one side is pull down and then forced up the other side as shown by arrow 84. This circular motion causes the contents of the container to be re-mixed to its intended consistency.

The present invention thus provides a practical and efficient portable way to maintain beverages that are mixed to the desired consistency.

While the foregoing specification teaches the principles of the present invention, with examples provided for the purpose of illustration, it will be appreciated by one skilled in the art from reading this disclosure that various changes in form and detail can be made without departing from the true scope of the invention.

We claim:

1. A beverage container with integral stirrer, said container comprising:
a main body adapted for hold a beverage;
a base upon which said main body is mounted;
at least one beverage stirrer mounted within said main body; and
an electric motor mounted within said base for operating said stirrer.

2. The beverage container of claim 1, wherein said beverage stirrer is formed of a plurality of blades.

3. The beverage container of claim 1, further comprising a control switch mounted on said base for controlling the operation of said electric motor.

4. The beverage container of claim 1, further comprising a control switch mounted within said base for controlling the operation of said electric motor.

5. The beverage container of claim 1, wherein said electric motor is battery operated.

6. The beverage container of claim 5, further comprising a battery compartment within said base for holding said battery.

7. The beverage container of claim 1, further comprising a timer for controlling the length of time that said motor operates.

8. The beverage container of claim 1, further comprising a temperature sensor for controlling when said motor operates.
